(19) United States
(12) Patent Application Publication
(10) Pub. No.: US 2017/0012414 A1
(43) Pub. Date: Jan. 12, 2017

(54) PLIERS CAPABLE OF PRECISELY STRIPPING A WIRE

(71) Applicant: SPERO FORGE CORPORATION, Taichung City (TW)

(72) Inventor: En-Sheng GONG, Taichung City (TW)

(21) Appl. No.: 14/959,858

(22) Filed: Dec. 4, 2015

(30) Foreign Application Priority Data
Jul. 9, 2015 (TW) 104122381

(51) Int. Cl. H02G 1/12; B25B 7/04

(52) U.S. Cl. CPC H02G 1/1209; B25B 7/04

(57) ABSTRACT

A pliers includes a first pliers body having a first neck section and a first handle, a second pliers body having a second neck section and a second handle, a pivot shaft disposed at the first and second neck sections of the first and second pliers bodies, two relative angular displacement positions respectively formed between the first and second neck sections, a stripping section having two blade sections respectively disposed on the two pliers bodies, and a scale section disposed on the relative angular displacement positions for controlling the gap between the two blade sections of the stripping section. With the scale section, the size of the stripping section is controllable, whereby the pliers can precisely peel off the insulation skin of the wire without damaging the conductive core therein.

### BACKGROUND OF THE INVENTION

1. Field of the Invention

The present invention relates generally to a pliers, and more particularly to a pliers capable of precisely stripping a wire.

2. Description of the Related Art

It is known that in common service and layout work of hydroelectric engineering, it is often necessary to peel off the insulation skins of various wires to expose the conductive cores in the wires for proper electrical connection. In the conventional wire stripping method, a pair of scissors, a knife or a pliers with sharp blades is often used as a tool for removing the insulation skin of the wire. However, such tool is not specifically designed for stripping the wire so that it is not handy for an operator to use such a tool to strip the wire. Especially, when stripping the wire with the tool, it is often uneasy for an operator with less practical experience to evaluate the holding force applied to the tool and successfully peel off the insulation skin of the wire. In the case that the force applied to the tool is too great, the conductive core inside the wire will be damaged to cause breakage or fission of the wire or even incautiously injure the operator's hand. Therefore, it is unsafe to use such a tool to strip the wire and unpredictable injury of human body may take place when using such a tool to strip the wire.

In the hand tool field, a specific wire stripping pliers is provided for stripping wires. However, such wire stripping pliers can be simply used to strip wires, while failing to achieve any other function.

### SUMMARY OF THE INVENTION

It is therefore a primary object of the present invention to provide a pliers capable of precisely peeling off the insulation skin of a wire without damaging the conductive core in the wire.

To achieve the above and other objects, the pliers capable of precisely stripping a wire of the present invention includes:
a first pliers body having a first jaw, a first neck section and a first handle, the first neck section being positioned between the first jaw and the first handle;
a second pliers body having a second jaw, a second neck section and a second handle, the second neck section being positioned between the second jaw and the second handle;
a pivot shaft disposed at the first and second neck sections of the first and second pliers bodies, whereby the two pliers bodies can be relatively rotated about the pivot shaft; two relative angular displacement positions being respectively formed between the first and second neck sections corresponding to each other;
a stripping section having a first blade section and a second blade section, the first and second blade sections being respectively disposed on the first and second pliers bodies, when the two pliers bodies are rotated, a gap between the two blade sections being adjustable;
a stripping reference position disposed on the stripping section; and
a scale section having multiple main scales and multiple cursor scales, multiple angular intervals being defined between the main scales and multiple angular intervals being defined between the cursor scales, the angular intervals between the main scales being different from the angular intervals between the cursor scales, the main scales and the cursor scales of the scale section being respectively disposed on the two relative angular displacement positions for controlling the gap between the two blade sections of the stripping section.

Accordingly, by means of the scale section of the pliers, an operator can adjust the gap between the two blade sections of the stripping section to the value of the diameter of the conductive core of the wire. In this case, the operator can use the pliers to precisely peel off the insulation skin of the wire without damaging the conductive core of the wire. Even an operator with less practical experience can easily and successfully perform the stripping work. Therefore, the utility of the pliers is increased and the pliers can be more conveniently used.

The present invention can be best understood through the following description and accompanying drawings, wherein:

### BRIEF DESCRIPTION OF THE DRAWINGS

FIG. 1 is a front view of a first embodiment of the pliers of the present invention;

FIG. 2 is a rear view of the first embodiment of the pliers of the present invention according to FIG. 1;

FIG. 3 is a front view of the first embodiment of the pliers of the present invention according to FIG. 1, showing the use of the pliers;

FIG. 4 is a rear view according to FIG. 3;

FIG. 5 is an enlarged view of a part of FIG. 3;

FIG. 6 is an enlarged view according to FIG. 5, showing the use of the pliers in another state;

FIG. 7 is an enlarged view according to FIG. 5, showing the use of the pliers in still another state;

FIG. 8 is a front view of the first embodiment of the pliers of the present invention in another aspect;

FIG. 9 is a front view of a second embodiment of the pliers of the present invention;

FIG. 10 is a front view of a third embodiment of the pliers of the present invention;

FIG. 11 is a front view of the third embodiment of the pliers of the present invention in another aspect;

FIG. 12 is a front view of a fourth embodiment of the pliers of the present invention;

FIG. 13 is a side view of the fourth embodiment of the pliers of the present invention according to FIG. 12; and

FIG. 14 is a front view of a fifth embodiment of the pliers of the present invention.

### DETAILED DESCRIPTION OF THE PREFERRED EMBODIMENTS

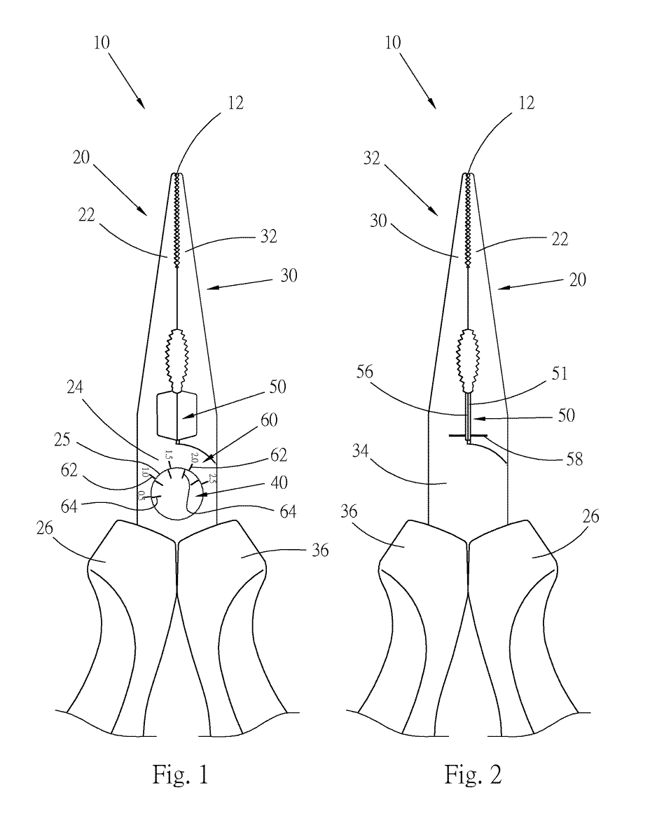

Please refer to FIGS. 1 and 2. In a first embodiment, the pliers 10 capable of precisely stripping a wire of the present invention is a pair of pliers for illustration purposes. The pliers 10 includes the following components.

A first pliers body 20 having a first jaw 22, a first neck section 24, a pivot hole 25 and a first handle 26. The first jaw 22 is disposed at a front end of the first pliers body 20. The first handle 26 is disposed at a rear end of the first pliers body 20. The first neck section 24 is positioned between the first jaw 22 and the first handle 26. The pivot hole 25 is formed through the first neck section 24.

A second pliers body 30 having a second jaw 32, a second neck section 34 and a second handle 36. The second jaw 32 is disposed at a front end of the second pliers body 30. The second handle 36 is disposed at a rear end of the second pliers body 30. The second neck section 34 is positioned between the second jaw 32 and the second handle 36.

A pivot shaft 40. In this embodiment, one end of the pivot shaft 40 is fixedly disposed on the second neck section 34 of the second pliers body 30 as a part of the second neck section 34. A free end of the pivot shaft 40 is pivotally disposed in the pivot hole 25 of the first pliers body 20, whereby the two pliers bodies 20, 30 can be relatively rotated about the pivot shaft 40. The first jaw 22 of the first pliers body 20 and the second jaw 32 of the second pliers body 30 define therebetween a pliers mouth 12.

A stripping section 50 disposed on a back face of the pliers 10. The stripping section 50 has a first blade section 51, a second blade section 56 and a stripping reference position 58. The first blade section 51 is positioned between the first jaw 22 and the first neck section 24 of the first pliers body 20 and disposed on an inner edge of the first pliers body 20. The second blade section 56 is positioned between the second jaw 32 and the second neck section 34 of the second pliers body 30 and disposed on an inner edge of the second pliers body 30 opposite to the first blade section 51. When the two pliers bodies 20, 30 are rotated, the gap between the two blade sections 51, 56 can be adjusted. The stripping reference position 58 is an indicator formed by such as a symbol, a mark or a laser sculpture. In this embodiment, the stripping reference position 58 has the form of a channel transversely disposed on outer surfaces of the two blade sections 51, 56 of the pliers 10. When the pliers 10 is used to strip a wire, the wire is aligned with and positioned in the stripping reference position 58. An operator can hold and force the two handles 26, 36 toward each other or unhold the two handles 26, 36 so as to adjust the gap between the two blade sections 51, 56 for receiving different diameters of wires.

A scale section 60 disposed on the front face of the pliers 10. The scale section 60 has multiple main scales 62 and multiple cursor scales 64. The angular intervals between the main scales 62 are larger than the angular intervals between the cursor scales 64. In this embodiment, the angular interval between the main scales 62 is 41 degrees, while the angular interval between the cursor scales 62 is 39 degrees. The main scales 62 are annularly disposed on the first neck section 24 of the first pliers body 20 along the pivot hole 25 of the first pliers body 20. The cursor scales 64 are annularly disposed on an end face of the free end of the pivot shaft 40 corresponding to the main scales 62. By means of relatively angularly moving the two neck sections 24, 34 of the two pliers bodies 20, 30, the scale section 60 serves to control the gap between the two blade sections 51, 56 of the stripping section 50.

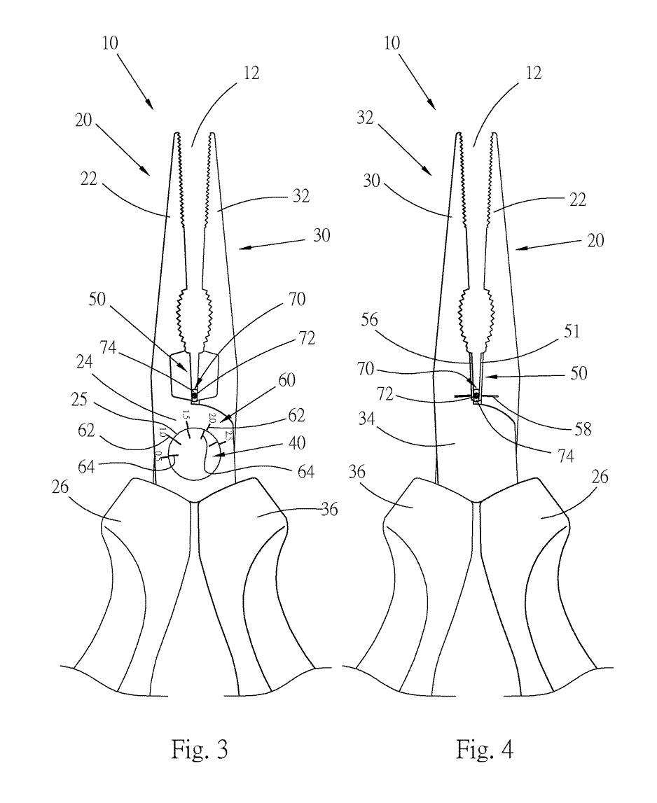

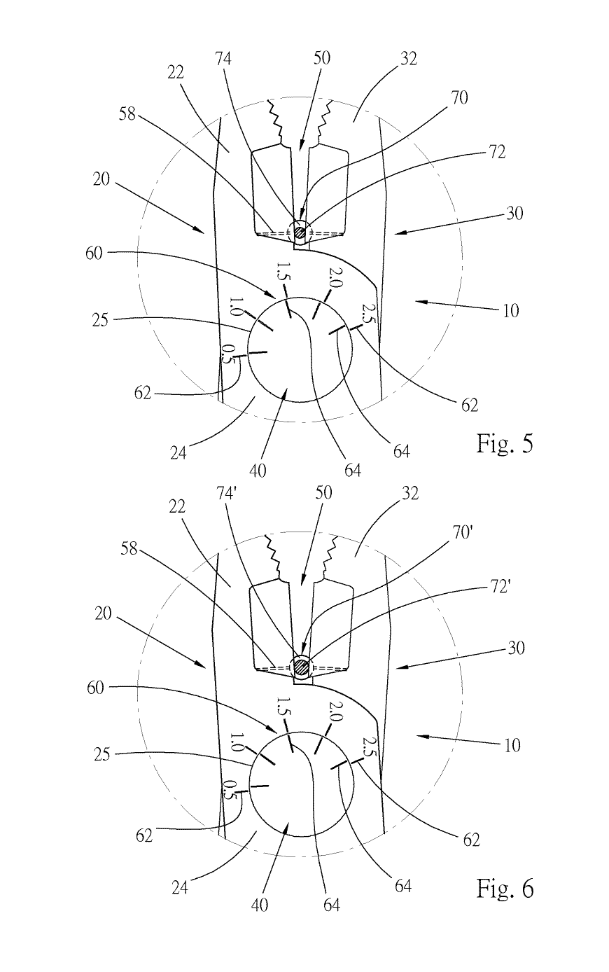

The use of the pliers 10 of the present invention will be described hereinafter. In addition to the holding function of a common pliers, the pliers 10 of the present invention can be further used to strip a wire. Please refer to FIGS. 3 to 5. When an operator uses the pliers 10 of the present invention to strip a wire 70, the wire 70 is aligned with and positioned in the stripping reference position 58 of the stripping section 50. The diameter of the conductive core 72 inside the wire 70 is previously checked or measured. Then, by means of the scale section 60, the operator checks whether the gap between the two blade sections 51, 56 of the stripping section 50 has been adjusted to a suitable value. For example, as shown in FIGS. 3 to 5, in the case that the diameter of the conductive core 72 of the wire 70 is 1.0 mm, by means of the two handles 26, 36, the two pliers bodies 20, 30 are relatively rotated to angularly move a cursor scale 64 of the scale section 60 on the pivot shaft 40 and align the cursor scale 64 with the main scale 62 of 1.0 mm disposed on the first neck section 24 of the first pliers body 20. At this time, the gap between the two blade sections 51, 56 of the stripping section 50 is also adjusted to 1.0 mm. Accordingly, the two blade sections 51, 56 of the stripping section 50 will only cut into the insulation skin 74 of the wire 70 without touching the conductive core 72 of the wire 70. When the pliers 10 is used to remove the insulation skin 74, the conductive core 72 is protected from damage and will keep complete.

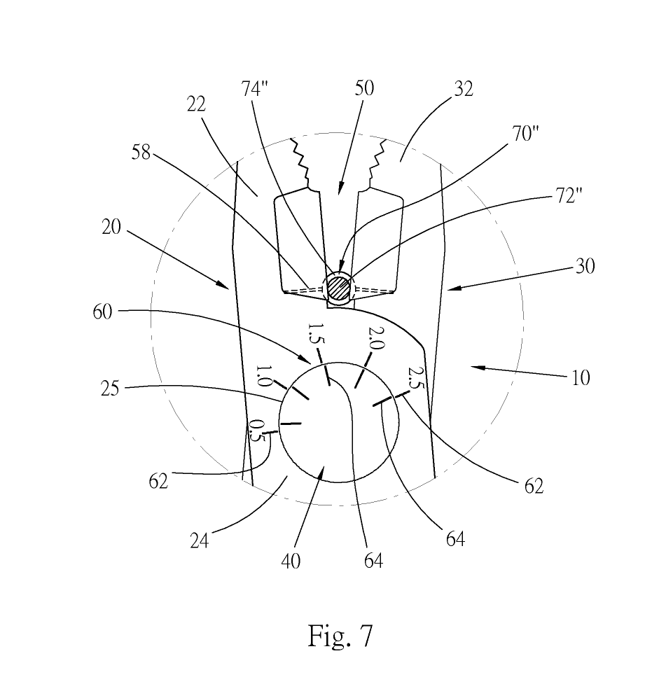

Further referring to FIGS. 6 and 7, in the case that the diameters of the conductive cores 72′, 72″ of the wire 70′, 70″ are respectively 1.5 mm and 2.0 mm, also by means of the two handles 26, 36, the two pliers bodies 20, 30 are relatively rotated to angularly move a cursor scale 64 of the scale section 60 on the pivot shaft 40 and respectively align the cursor scale 64 with the main scales 62 of 1.5 mm and 2.0 mm disposed on the first neck section 24 of the first pliers body 20. At this time, the gaps between the two blade sections 51, 56 of the stripping section 50 are also respectively adjusted to 1.5 mm and 2.0 mm. Accordingly, the insulation skins 74′, 74″ of the wires 70′, 70″ can be smoothly removed to successfully complete the stripping operation.

According to the above, by means of the scale section 60, an operator can precisely adjust the gap between the two blade sections 51, 56 of the stripping section 50 to the value of the diameter of the conductive core 72 of the wire 70 so as to easily and quickly remove the insulation skin 74 of the wire 70 without damaging the conductive core 72 inside the wire 70. Also, the operator no longer needs to first evaluate the holding force applied to the two handles 26, 36 simply with his previous use experience and then strip the wire 70. Instead, the operator can directly visually observe the scale section 60 to know whether the current holding force makes the two blade sections 51, 56 of the stripping section 50 just cut into the insulation skin 74 of the wire 70 without damaging the conductive core 72 of the wire 70. In this case, even an operator with less practical experience can easily perform the stripping work by means of the pliers 10. Therefore, the pliers 10 can be more conveniently used and the utility of the pliers 10 is increased.

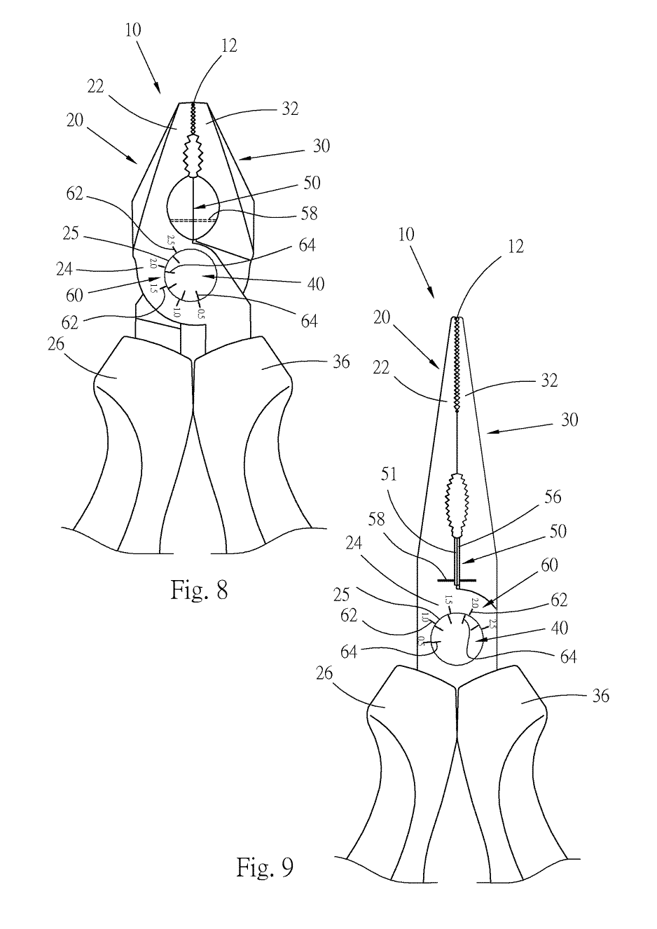

The scale section 60 of the present invention is also applicable to other types of pliers. Please refer to FIG. 8, which is a front view of the first embodiment of the pliers of the present invention in another aspect. In this aspect, the pliers 10 has a stripping section 50 and a scale section 60. An operator can use the scale section 60 to adjust the stripping section 50 for stripping the wire. The usage of the pliers is identical to that of the aforementioned pliers and thus will not be repeatedly described hereinafter.

Please now refer to FIG. 9, which is a front view of a second embodiment of the pliers 10 capable of precisely stripping a wire of the present invention. In the second embodiment, the pliers 10 also includes a first pliers body 20, a second pliers body 30, a pivot shaft 40, a stripping section 50 and a scale section 60. The second embodiment is different from the first embodiment in that the stripping section 50 and the scale section 60 are both disposed on the front face of the pliers 10. When an operator uses the scale section 60 to adjust the gap between the two blade sections 51, 56 of the stripping section 50, the operator needn't turn over the pliers 10. Instead, the operator can directly visually observe the scale section 60 to conveniently and quickly know the gap between the two blade sections 51, 56 of the stripping section 50 and further adjust the gap between the two blade sections 51, 56. Accordingly, the operator can more quickly and conveniently adjust the stripping section 50 to complete the stripping operation.

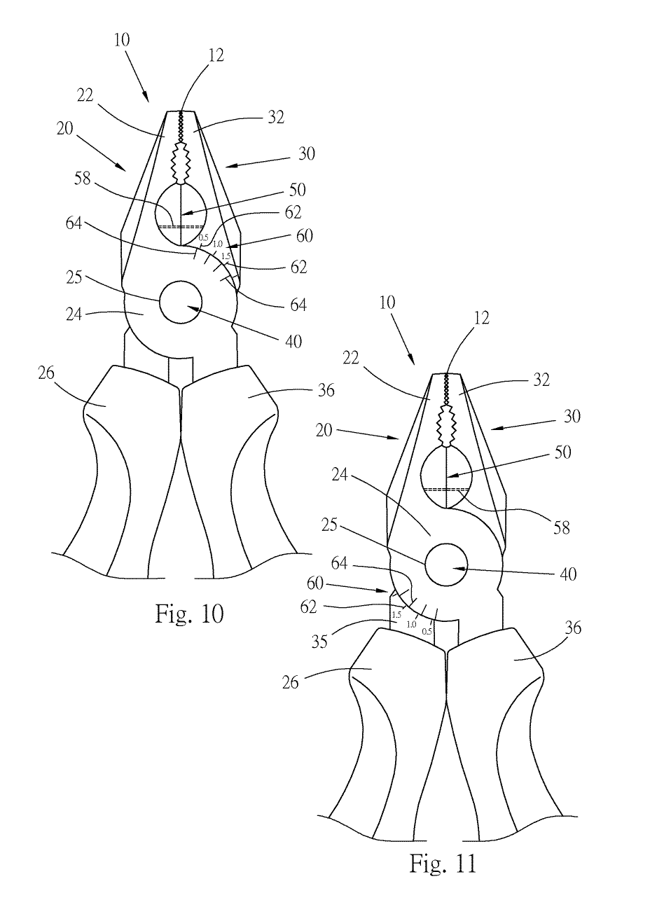

Please refer to FIG. 10, which is a front view of a third embodiment of the pliers 10 capable of precisely stripping a wire of the present invention. In this embodiment, the pliers 10 includes a first pliers body 20, a second pliers body 30, a pivot shaft 40, a stripping section 50 and a scale section 60. The third embodiment is different from the first embodiment in that when the first and second pliers bodies 20, 30 are relatively rotated, the lower end of the second jaw 32 of the second pliers body 30 is angularly moved relative to an outer circumference of the first neck section 24 of the first pliers body 20. The cursor scales 64 are disposed on the first neck section 24 of the first pliers body 20 along the outer circumference of the first neck section 24. The main scales 62 are disposed on the second jaw 22 of the second pliers body 30 along a lower edge of the second jaw 32 corresponding to the cursor scales 64.

Accordingly, by means of relatively angularly moving the first and second pliers bodies 20, 30, the main scales 62 and the cursor scales 64 of the scale section 60 can show the gap between the two blade sections 51, 56 of the stripping section 50. An operator can know the gap between the two blade sections 51, 56 from the scale section 60 to further adjust the gap between the two blade sections 51, 56 in accordance with the width of the conductive core 72 of the wire 70. Therefore, the operator can conveniently perform the stripping work.

Please refer to FIG. 11, which is a front view of the third embodiment of the pliers of the present invention in another aspect. In this aspect, the second neck section 34 of the second pliers body 30 has a connection section 35 connected with the second handle 36. The cursor scales 64 are disposed along an outer circumference of the first neck section 24 of the first pliers body 20. The main scales 62 are disposed along an upper edge of the connection section 35 of the second pliers body 30 corresponding to the cursor scales 64.

Accordingly, by means of relatively angularly moving the first and second pliers bodies 20, 30, the scale section 60 can show the gap between the two blade sections 51, 56 of the stripping section 50. Therefore, an operator can conveniently adjust the gap between the two blade sections 51, 56 to perform the stripping operation.

It should be noted that in this embodiment, the pivot shaft 40 is not limited to be fixedly disposed on the second pliers body 30. Alternatively, the pivot shaft 40 can be pivotally passed through the first neck section 24 of the first pliers body 20 and the second neck section 34 of the second pliers body 30.

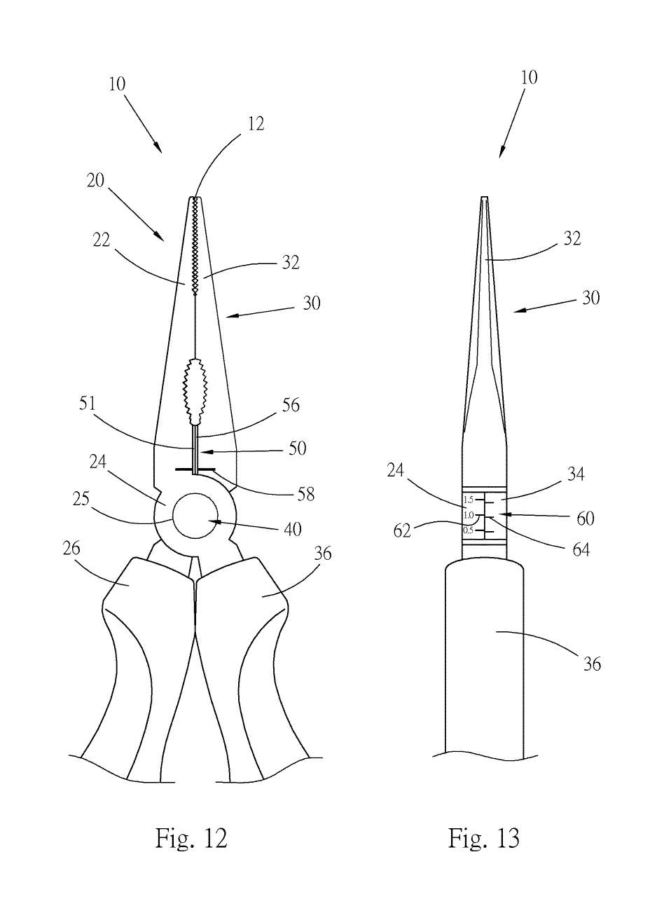

Please refer to FIGS. 12 and 13. FIG. 12 is a front view of a fourth embodiment of the pliers 10 capable of precisely stripping a wire of the present invention. FIG. 13 is a side view of the fourth embodiment of the pliers capable of precisely stripping a wire of the present invention according to FIG. 12. In the fourth embodiment, the pliers 10 also includes a first pliers body 20, a second pliers body 30, a pivot shaft 40, a stripping section 50 and a scale section 60. The neck sections 24, 34 of the two pliers bodies 20, 30 are overlapped with each other. The fourth embodiment is different from the first embodiment in that the main scales 62 of the scale section 60 are disposed on a lateral face of the first neck section 24 of the first pliers body 20. The cursor scales 64 are disposed on a lateral face of the second neck section 34 of the second pliers body 30 on the same side as the main scales 62 corresponding to the main scales 62.

Accordingly, an operator can quickly and conveniently know the gap between the two blade sections 51, 56 of the stripping section 50 from the scale section 60 disposed on the lateral face of the pliers 10. In this case, the operator no more needs to turn over the pliers 10 to see the front face or the back face of the pliers 10 for knowing the gap between the two blade sections 51, 56. Accordingly, the use efficiency of the pliers 10 can be enhanced.

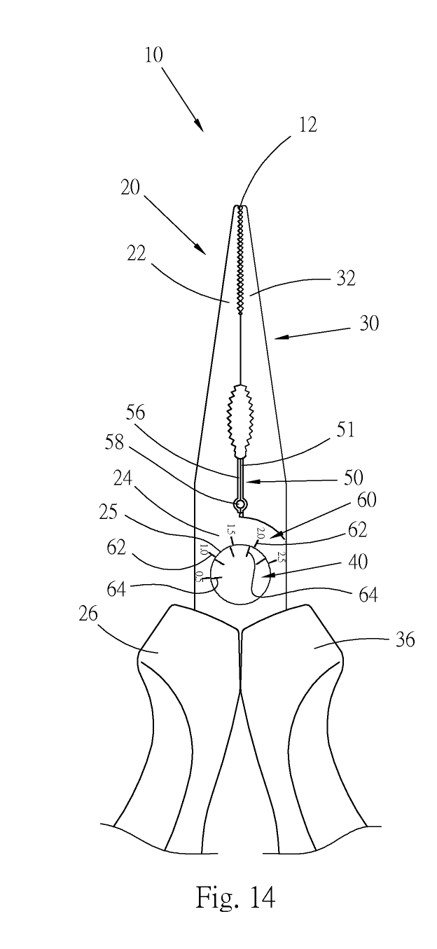

Please refer to FIG. 14, which is a front view of a fifth embodiment of the pliers capable of precisely stripping a wire of the present invention. The fifth embodiment is substantially identical to the first, second and third embodiments in structure. The same components are denoted with the same reference numerals and will not be repeatedly described hereinafter. The fifth embodiment is different from the above embodiments in that the stripping reference position 58 of the stripping section 50 has a circular form and is disposed in the two blade sections 51, 56. The wire 70 and the stripping reference position 58 both have a circular configuration. Therefore, when the wire 70 is aligned with and positioned in the stripping reference position 58, the wire 70 can more snugly attach to the stripping reference position 58. When the stripping section 50 strips the wire 70, since the stripping reference position 58 annularly surrounds the outer circumference of the wire 70, the insulation skin 74 can be completely cut by the two blade sections 51, 56. Therefore, an operator can easily remove the insulation skin 74 without consuming too much time or strength. Accordingly, the utility of the pliers 10 is enhanced.

In the pliers 10 of the present invention, by means of the scale section, the gap between the two blade sections of the stripping section can be precisely adjusted to the diameter of the conductive core of the wire. Under such circumstance, when an operator uses the pliers to peel off the insulation skin of the wire, the operator can easily and quickly remove the insulation skin without damaging the conductive core. Moreover, the operator can directly visually observe the scale section to know the current gap between the two blade sections of the stripping section. Therefore, the operator no longer needs to first evaluate the holding force applied to the pliers simply with his previous stripping experience and then strip the wire. In this case, even an operator with less practical experience can easily and successfully perform the stripping work by means of the pliers. Therefore, the utility of the pliers is enhanced and the pliers can be more conveniently operated.

The above embodiments are only used to illustrate the present invention, not intended to limit the scope thereof. Many modifications of the above embodiments can be made without departing from the spirit of the present invention.

What is claimed is:

1. A pliers capable of precisely stripping a wire, comprising:
a first pliers body having a first jaw, a first neck section and a first handle, the first jaw being disposed at a front end of the first pliers body, the first handle being disposed at a rear end of the first pliers body, the first neck section being positioned between the first jaw and the first handle;
a second pliers body having a second jaw, a second neck section and a second handle, the second jaw being disposed at a front end of the second pliers body, the second handle being disposed at a rear end of the second pliers body, the second neck section being positioned between the second jaw and the second handle;
a pivot shaft disposed at the first and second neck sections of the first and second pliers bodies, whereby the two pliers bodies can be relatively rotated about the pivot shaft; two relative angular displacement positions being respectively formed between the first and second neck sections corresponding to each other;
a stripping section having a first blade section and a second blade section, the first blade section being disposed on an inner edge of the first pliers body, the second blade section being disposed on an inner edge of the second pliers body opposite to the first blade section, when the two pliers bodies are rotated, a gap between the two blade sections being adjustable;
a stripping reference position disposed on the stripping section; and
a scale section having multiple main scales and multiple cursor scales, multiple angular intervals being defined between the main scales and multiple angular intervals being defined between the cursor scales, the angular intervals between the main scales being different from the angular intervals between the cursor scales, the main scales and the cursor scales of the scale section being respectively disposed on the two relative angular displacement positions.

2. The pliers as claimed in claim 1, wherein one end of the pivot shaft is fixedly disposed on the second neck section of the second pliers body as a part of the second neck section, whereby when the second pliers body is rotated, the pivot shaft is rotated along with the second pliers body, the main scales being annularly disposed on the first neck section of the first pliers body along the pivot shaft, the cursor scales being annularly disposed on an end face of the free end of the pivot shaft corresponding to the main scales.

3. The pliers as claimed in claim 1, wherein when the first and second pliers bodies are relatively rotated, a lower end of the second jaw of the second pliers body being angularly moved relative to the first neck section of the first pliers body, the cursor scales being disposed along an outer circumference of the first neck section of the first pliers body, the main scales being disposed along a lower edge of the second jaw of the second pliers body corresponding to the main scales.

4. The pliers as claimed in claim 1, wherein the second neck section of the second pliers body has a connection section connected with the second handle, when the first and second pliers bodies are relatively rotated, an upper end of the connection section of the second pliers body being angularly moved relative to the first neck section of the first pliers body, the cursor scales being disposed along an outer circumference of the first neck section of the first pliers body, the main scales being disposed along an upper edge of the connection section of the second pliers body corresponding to the main scales.

5. The pliers as claimed in claim 1, wherein the first and second neck sections of the first and second pliers bodies are overlapped with each other, the main scales being disposed on a lateral face of the first neck section of the first pliers body, the cursor scales being disposed on a lateral face of the second neck section of the second pliers body corresponding to the main scales of the first pliers body.

6. The pliers as claimed in claim 1, wherein the pliers has a front face, a back face and two lateral faces, the stripping section and the scale section are positioned on different faces of the pliers.

7. The pliers as claimed in claim 2, wherein the pliers has a front face, a back face and two lateral faces, the stripping section and the scale section are positioned on different faces of the pliers.

8. The pliers as claimed in claim 3, wherein the pliers has a front face, a back face and two lateral faces, the stripping section and the scale section are positioned on different faces of the pliers.

9. The pliers as claimed in claim 4, wherein the pliers has a front face, a back face and two lateral faces, the stripping section and the scale section are positioned on different faces of the pliers.

10. The pliers as claimed in claim 1, wherein the pliers has a front face, a back face and two lateral faces, the stripping section and the scale section are positioned on the same face of the pliers.

11. The pliers as claimed in claim 2, wherein the pliers has a front face, a back face and two lateral faces, the stripping section and the scale section are positioned on the same face of the pliers.

12. The pliers as claimed in claim 3, wherein the pliers has a front face, a back face and two lateral faces, the stripping section and the scale section are positioned on the same face of the pliers.

13. The pliers as claimed in claim 4, wherein the pliers has a front face, a back face and two lateral faces, the stripping section and the scale section are positioned on the same face of the pliers.

14. The pliers as claimed in claim 1, wherein the stripping reference position of the stripping section is an indicator.

15. The pliers as claimed in claim 1, wherein the stripping reference position of the stripping section has a circular configuration.

16. The pliers as claimed in claim 1, wherein the angular intervals between the main scales are larger than the angular intervals between the cursor scales.
